(19) United States
(12) Patent Application Publication
(10) Pub. No.: US 2010/0304970 A1
(43) Pub. Date: Dec. 2, 2010

(54) HERBICIDAL COMPOSITION

(75) Inventor: Toshiyuki TANEDANI, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Osaka (JP)

(21) Appl. No.: 12/854,979

(22) Filed: Aug. 12, 2010

Related U.S. Application Data
(63) Continuation of application No. 10/964,897, filed on Oct. 15, 2004, now abandoned.

(30) Foreign Application Priority Data
Oct. 21, 2003 (JP) 2003-360326

(51) Int. Cl. A01N 43/84; A01N 57/00; A01P 13/00

(52) U.S. Cl. 504/128; 504/118; 504/130

(57) ABSTRACT

A herbicidal composition which comprises a protoporphyrinogen oxidase inhibiting herbicidal active ingredient, a water-soluble herbicidal active ingredient, a water-soluble anionic surfactant, a polyoxyalkylenehydrocarbylamine, a water-immiscible organic solvent in which the protoporphyrinogen oxidase inhibiting herbicidal active ingredient cannot be substantially dissolved, a thickner and water, wherein the protoporphyrinogen oxidase inhibiting herbicidal active ingredient is suspended in the water dissolving the water-soluble herbicidal active ingredient as solid fine particles has excellent suspension stability.

### CROSS REFERENCE TO RELATED APPLICATIONS

This is a continuation of application Ser. No. 10/964,897 filed Oct. 15, 2004, which claims priority from Japanese Patent Application No. 2003-360326 filed Oct. 21, 2003. The entire disclosures of the prior applications are hereby incorporated by reference.

### TECHNICAL FIELD

The present invention directs to a herbicidal composition that contains a water-insoluble solid herbicidal active ingredient and a water-soluble herbicidal active ingredient, especially a herbicidal composition containing a protoporphyrinogen oxidase inhibiting herbicidal active ingredient and a water-soluble herbicidal active ingredient.

### BACKGROUND ART

In agricultural production, mixed formulations containing two or more pesticidal active ingredients are used for various objects.

For example, water-soluble herbicidal active ingredients such as salts of N-phosphonomethylglycine and salts of 4-[hydroxyl(methyl) phosphinoyl]-DL-homoalanine are widely used as active ingredients of herbicides. As these herbicidal active ingredients require time to express their herbicidal effects, proposed were some herbicidal compositions containing said herbicidal active ingredient and a water-insoluble herbicidal active ingredient having rapid efficacy such as protoporphyrinogen oxidase inhibiting herbicidal active ingredient. These herbicidal compositions are disclosed in U.S. Pat. No. 4,994,102 and U.S. Pat. No. 5,698,492; however, it is not always easy to obtain an aqueous formulation keeping a stable suspension condition of the protoporphyrinogen oxidase inhibiting herbicidal active ingredient.

### DISCLOSURE OF THE INVENTION

The present invention provides a herbicidal composition comprising a protoporphyrinogen oxidase inhibiting herbicidal active ingredient and a water-soluble herbicidal active ingredient that is a stable aqueous flowable formulation. Namely, in the herbicidal composition of the present invention, the protoporphyrinogen oxidase inhibiting herbicidal active ingredient is suspended in water containing a water-soluble herbicidal active ingredient, and the herbicidal composition is excellent in the suspension stability.

The herbicidal composition of the present invention comprises a protoporphyrinogen oxidase inhibiting herbicidal active ingredient, a water-soluble herbicidal active ingredient, a water-soluble anionic surfactant, a polyoxyalkylenehydrocarbylamine, a water-immiscible organic solvent in which the protoporphyrinogen oxidase inhibiting herbicidal active ingredient cannot be substantially dissolved, a thickner and water, wherein the protoporphyrinogen oxidase inhibiting herbicidal active ingredient is suspended as solid fine particles in the water dissolving the water-soluble herbicidal active ingredient.

In the herbicidal composition of the present invention, the protoporphyrinogen oxidase inhibiting herbicidal active ingredient is usually suspended as solid fine particles enveloped in a barrier layer containing a water-soluble anionic surfactant, a polyoxyalkylenehydrocarbylamine and a water-immiscible organic solvent in which said protoporphyrinogen oxidase inhibiting herbicidal active ingredient cannot be substantially dissolved.

Therefore, the herbicidal composition of the present invention can be an aqueous flowable composition wherein fine particles of a protoporphyrinogen oxidase inhibiting herbicidal active ingredient, enveloped in a barrier layer containing a water-soluble anionic surfactant, a polyoxyalkylenehydrocarbylamine and a water-immiscible organic solvent in which said protoporphyrinogen oxidase inhibiting herbicidal active ingredient cannot be substantially dissolved, are suspended in an aqueous phase containing a water-soluble herbicidal active ingredient and a thickner.

In addition, the barrier layer, which contains a water-soluble anionic surfactant, a polyoxyalkylenehydrocarbylamine and a water-immiscible organic solvent in which said protoporphyrinogen oxidase inhibiting herbicidal active ingredient cannot be substantially dissolved, comprises one or more fine particles of the protoporphyrinogen oxidase inhibiting herbicidal active ingredient.

The herbicidal composition of the present invention is an aqueous herbicidal flowable composition, wherein the protoporphyrinogen oxidase inhibiting herbicidal active ingredient is suspended in the water dissolving a water-soluble herbicidal active ingredient, and has an excellent suspension stability of said protoporphyrinogen oxidase inhibiting herbicidal active ingredient.

In the herbicidal composition of the present invention, the protoporphyrinogen oxidase inhibiting herbicidal active ingredient is generally a herbicidal ingredient being solid at 25° C. and having 10 g/L or less of water solubility at 25° C., and preferably having 60° C. or more of melting point. Further, the protoporphyrinogen oxidase inhibiting herbicidal active ingredient can have 1.2 to 3.0 of specific gravity.

Examples of the protoporphyrinogen oxidase inhibiting herbicidal active ingredient include azafenidin, bifenox, sulfentrazone, pyraflufen-ethyl, flumicrolac-pentyl and flumioxazin. Typical example is flumioxazin whose chemical name is N-(7-fluoro-3,4-dihydro-3-oxo-4-prop-2-ynyl-2H-1,4-benzoxadin-6-yl)cyclohex-1-en-1,2-dicarboxamide.

The average diameter of the protoporphyrinogen oxidase inhibiting herbicidal active ingredient is usually 20 μm or less, preferably 0.1 to 10 μm of volume median diameter. The content of the protoporphyrinogen oxidase inhibiting herbicidal active ingredient is usually 0.5 to 50 w/v % in the herbicidal composition of the present invention.

In the herbicidal composition of the present invention, the water-soluble herbicidal active ingredient is a herbicidal ingredient being freely soluble in water which has 100 g/L or more of solubility in water at 25° C.

Examples of the water-soluble herbicidal active ingredient include glufosinate, glyphosate, acrolein, amitrole, bialaphos, chloroacetic acid, clopyralid, dalapon, difenzoquat, diquat, endothal, flamprop, fluazifop, fluoroglycofen, flupropanate, fosamine, imazapic, imazamethabenz, imazamox, imazapic, methylarsonic acid, paraquat, sulfamic acid, trichloroacetic acid, bentazone and their water soluble salts. Typical examples of the water-soluble herbicidal active ingredient are amino acid type herbicidal active ingredients such as glyphosate whose chemical name is N-phosphonomethylglycine, glufosinate whose chemical name is 4-[hydroxyl(methyl)phosphinoyl]-DL-homoalanine and their water-soluble salts.

The content of the water-soluble herbicidal active ingredient is usually 5 to 60 w/v % in the herbicidal composition of the present invention.

The weight ratio of the protoporphyrinogen oxidase inhibiting herbicidal active ingredient and the water-soluble herbicidal active ingredient in the herbicidal composition of the present invention is usually 4.5/1-1/10, preferably 3/1-1/3.

The content of the total amount of the protoporphyrinogen oxidase inhibiting herbicidal active ingredient and the water-soluble herbicidal active ingredient is usually 5.5 to 60 w/v % in the aqueous herbicidal composition of the present invention.

In the herbicidal composition of the present invention, the water-soluble anionic surfactant has 10 g/L or more of solubility in water at 25° C. The water-soluble anionic surfactant used for the herbicidal composition of the present invention means a surfactant that dissociates into ions in an aqueous solution to form an anion in the portion giving surfactant-activity. It usually has 15 or more of HLB value.

The water-soluble anionic surfactant used for the herbicidal composition of the present invention can be carboxylate, sulfonate, sulfate or phosphate surfactant.

Examples of the carboxylate surfactant include higher fatty acid salts, alkylether carboxylic acid salts, fatty amide ether carboxylic acid salts, acyllactic acid salts, N-acylglutamic acid salts, N-acylalanine salts, N-acyltaurine salts, N-acylsarcosine salts, N-acyl-ω-amino acid salts and polymeric unsaturated carboxylic acid salts.

Examples of the sulfonate surfactant include alkanesulfonic acid salts, α-olefinsulfonic acid salts, α-sulfofatty acid methyl ester salts, acylisethionic acid salts, alkylglycidyl ether sulfonic acid salts, alkylsulfosuccinic acid salts, dialkylsulfosuccinic acid salts, alkylsulfoacetic acid salts, alkylbenzenesulfonic acid salts, alkylnaphthalenesulfonic acid salts, N-acylmethyltaurine salts, formalin-condensed sulfonic acid salts and ligninsulfonic acid salts (e.g. sodium ligninsulfonate).

Examples of the sulfate surfactant include alkylsulfuric acid salts, alkyl ether sulfuric acid salts, alkyl aryl ether sulfuric acid salts, fatty acid alkanolamido sulfuric acid salts and fatty acid monoglyceride sulfuric acid salts.

Examples of the phosphate surfactants include alkylphosphoric acid salts, polyoxyethylene alkyl ether phosphoric acid salts, alkyl aryl ether phosphoric acid salts and fatty amide ether phosphoric acid salts.

The content of the water-soluble anionic surfactant is usually 0.5 to 10 w/v % in the herbicidal composition of the present invention.

In the herbicidal composition of the present invention, polyoxyalkylenehydrocarbylamine is an amine compound substituted with one or two polyoxyalkylene groups and one or two monovalent hydrocarbyl groups. The polyoxyalkylenehydrocarbylamine can be prepared by the addition reaction of alkylene oxide to alkylamine. For example, a higher alkylamine reacts with ethylene oxide to afford a secondary amine substituted with one polyoxyethylene group and one alkyl group and/or a tertially amine substituted with two polyoxyethylene groups and one alkyl group. Examples of the monovalent hydrocarbyl group include C8-C20 alkyl group and C8-C20 alkenyl group. In the herbicidal composition of the present invention, examples of the polyoxyalkylenehydrocarbylamine include polyoxyalkylenealkylamine and polyoxyalkylenealkenylamine, typically polyoxyethylene tallowamine.

In the herbicidal composition of the present invention, polyoxyalkylenehydrocarbylamine having 15 or less of HLB is usually used. Preferably used is one having 8 to 12 of HLB.

The content of the polyoxyalkylenehydrocarbylamine is usually 0.1 to 20 w/v % in the herbicidal composition of the present invention.

The herbicidal composition of the present invention comprises a water-immiscible organic solvent in which the protoporphyrinogen oxidase inhibiting herbicidal active ingredient cannot be substantially dissolved.

The water-immiscible organic solvent has 10 g/L or less of solubility to water at 25° C. and the protoporphyrinogen oxidase inhibiting herbicidal active ingredient has 1 g/L or less of solubility to the water-immiscible organic solvent.

The water-immiscible organic solvent can be suitably selected by considering the kind of the protoporphyrinogen oxidase inhibiting herbicidal active ingredient in the herbicidal composition of the present invention. When flumioxazin is used for the protoporphyrinogen oxidase inhibiting herbicidal active ingredient, examples of the water-immiscible organic solvent include phenylxylylethane, alkyl esters of higher fatty acid and linseed oil. Typical alkyl esters of higher fatty acid are C1-C4 alkyl esters of saturated or unsaturated C12-C18 fatty acid such as methyl oleate.

The content of the water-immiscible organic solvent is usually 1 to 30 w/v %, preferably 3 to 25 w/v %, more preferably 4 to 20 w/v %, in the herbicidal composition of the present invention.

Examples of the thickner in the herbicidal composition of the present invention include magnesium silicates, aluminum silicates, bentonite, smectite and polysaccharide.

Said magnesium silicates are synthetic hydrated sodium lithium magnesium silicate and so on, and said aluminum silicates are magnesium aluminum silicate and so on. Examples of the polysaccharide include xanthan gum, rhamsan gum, locust bean gum, carrageenan, welan gum, starch and carboxymethylcellulose.

Magnesium silicates are preferably used for the thickner in the herbicidal composition of the present invention in the view of formulation stability.

The content of the thickner is usually 0.01 to 10 w/v %, preferably 0.1 to 5 w/v %, in the herbicidal composition of the present invention.

Further, water is usually 0.1 to 94.25 w/v %, preferably 10 to 55 w/v %, in the herbicidal composition of the present invention.

The herbicidal composition of the present invention may optionally comprise another surfactant, antifoaming agent, antifreezing agent, preservative, stabilizing agent, coloring agent, perfume, synergist, safener and so on.

Examples of the other surfactant include nonionic surfactants such as polyoxyalkylene alkyl ether (e.g. polyoxyethylene alkyl ether), polyoxyalkylene alkenyl ether (e.g. polyoxyethylene alkenyl ether), polyoxyalkylene alkyl phenyl ether, polyoxyalkylene castor oil, polyoxyalkylene hydrogenated castor oil, polyoxyalkylene fatty acid ester, fatty acid ester of glycerin and sorbitan fatty acid ester, and so on. When the other surfactant is used, the content is usually approximately 1 to 10 w/v % in the herbicidal composition of the present invention.

Examples of the antifoaming agent include silicone antifoaming agents such as Antifoam C (commercial name of Dow Corning), Antifoam CE (commercial name of Dow Corning), TSA730 (commercial name of Toshiba Silicone), TSA732 (commercial name of Toshiba Silicone) and YMA6509 (commercial name of Toshiba Silicone); and fluorinated antifoaming agents such as FLUOWET PL80 (commercial name of Clariant). When the antifoaming agent is used, the content is usually approximately 0.001 to 3 w/v % in the herbicidal composition of the present invention.

Examples of the antifreezing agent include water soluble glycols such as ethylene glycol and propylene glycol. When the antifreezin agent is used, the content is usually approximately 0.5 to 30 w/v %, preferably 1 to 20 w/v %, in the herbicidal composition of the present invention.

Examples of the preservative include esters of p-hydroxybenzoic acid, salicylic acid derivatives and isothiazolin-3-one derivatives. When the preservative is used, the content is usually approximately 0.01 to 5 w/v %, preferably 0.05 to 3 w/v %, in the herbicidal composition of the present invention.

Examples of the stabilizing agent include a mixture of silica with a metal oxide such as silica with aluminum oxide. The mixing ratio of silica and aluminum oxide is usually 1:1 to 99:1. Examples of the mixture of silica with aluminum oxide include AEROSIL MOX80, AEROSIL MOX170, AEROSIL COK-84 (manufactured by Degussa Huls) on the market. When the stabilizing agent is used, the content is usually approximately 0.01 to 10 w/v %, preferably 0.1 to 5 w/v %, in the herbicidal composition of the present invention.

The embodiments of the herbicidal composition of the present invention are, for example, as follows:

(1) A herbicidal composition, wherein the protoporphyrinogen oxidase inhibiting herbicidal active ingredient is flumioxazin, the water-soluble anionic surfactant is a ligninsulfonic acid salt and the water-immiscible organic solvent is methyl oleate.

In that case, preferable is the herbicidal composition, wherein the weight ratio of flumioxazin, ligninsulfonic acid salt, polyoxyalkylenehydrocarbylamine and methyl oleate is 1/0.01-1/0.01-2/0.1-2, in the view of the suspension stability.

(2) A herbicidal composition, wherein the protoporphyrinogen oxidase inhibiting herbicidal active ingredient is flumioxazin, the water-soluble herbicidal active ingredient is a glyphosate salt, the water-soluble anionic surfactant is a ligninsulfonic acid salt and the water-immiscible organic solvent is methyl oleate.
(3) A herbicidal composition, wherein the protoporphyrinogen oxidase inhibiting herbicidal active ingredient is flumioxazin, the water-soluble anionic surfactant is a ligninsulfonic acid salt, the water-immiscible organic solvent is methyl oleate and the thickner is a magnesium silicate.
(4) A herbicidal composition, wherein the protoporphyrinogen oxidase inhibiting herbicidal active ingredient is flumioxazin, the water-soluble anionic surfactant is a ligninsulfonic acid salt, the water-immiscible organic solvent is methyl oleate and the thickner is bentonite.
(5) A herbicidal composition, wherein the protoporphyrinogen oxidase inhibiting herbicidal active ingredient is flumioxazin, the water-soluble anionic surfactant is a ligninsulfonic acid salt, the water-immiscible organic solvent is methyl oleate and the thickner is smectite.
(6) A herbicidal composition, wherein the protoporphyrinogen oxidase inhibiting herbicidal active ingredient is flumioxazin, the water-soluble herbicidal active ingredient is a glyphosate salt, the water-soluble anionic surfactant is a ligninsulfonic acid salt, the water-immiscible organic solvent is methyl oleate and the thickner is a magnesium silicate.
(7) A herbicidal composition, wherein the protoporphyrinogen oxidase inhibiting herbicidal active ingredient is flumioxazin, the water-soluble herbicidal active ingredient is a glyphosate salt, the water-soluble anionic surfactant is a ligninsulfonic acid salt, the water-immiscible organic solvent is methyl oleate and the thickner is bentonite.
(8) A herbicidal composition, wherein the protoporphyrinogen oxidase inhibiting herbicidal active ingredient is flumioxazin, the water-soluble herbicidal active ingredient is a glyphosate salt, the water-soluble anionic surfactant is a ligninsulfonic acid salt, the water-immiscible organic solvent is methyl oleate and the thickner is smectite.
(9) A herbicidal composition, wherein the protoporphyrinogen oxidase inhibiting herbicidal active ingredient is flumioxazin, the water-soluble anionic surfactant is a ligninsulfonic acid salt and the water-immiscible organic solvent is methyl oleate, and further comprising polyoxyethylene alkyl ether.

The herbicidal composition of the present invention can be, for example, produced by mixing an aqueous solution of the water⁻soluble herbicidal active ingredient with a slurry containing the protoporphyrinogen oxidase inhibiting herbicidal active ingredient, the water-soluble anionic surfactant and water, and then adding a polyoxyalkylenehydrocarbylamine, the water-immiscible organic solvent, the thickner, and optionally the other component thereto.

The slurry containing the protoporphyrinogen oxidase inhibiting herbicidal active ingredient, the water-soluble anionic surfactant and water can be prepared by mixing the protoporphyrinogen oxidase inhibiting herbicidal active ingredient, the water-soluble anionic surfactant and water, and wet-pulverizing. Typical procedure is a method of adding hard beads (e.g. glass beads) to a mixture of the protoporphyrinogen oxidase inhibiting herbicidal active ingredient, the water-soluble anionic surfactant and water, and stirring.

The step for mixing the aqueous solution of the water-soluble herbicidal active ingredient with the slurry containing the protoporphyrinogen oxidase inhibiting herbicidal active ingredient, the water-soluble anionic surfactant and water is usually performed under high-speed stirring (approximately 1000-10000 rpm). The next step for adding the water-immiscible organic solvent, the thickner, and optionally the other component thereto is usually performed adding a polyoxyalkylenehydrocarbylamine, the water-immiscible organic solvent, the thickner, and optionally the other component in the suitable order under keeping the high-speed stirring, after mixing the aqueous solution of the pesticidal ingredient being freely soluble in water with the slurry containing the protoporphyrinogen oxidase inhibiting herbicidal active ingredient, the water-soluble anionic surfactant and water under high-speed stirring.

The concentraction of the herbicidal active ingredients in the herbicidal composition of the present invention obtained above can be adjusted by an addition of water if necessary.

The herbicidal composition of the present invention can be, for example, diluted with water just before the application and provided to the application to soil, plants or the like in an effective amount of the active ingredients.

### EXAMPLES

Hereinafter, the present invention is explained by production examples and so on in more detail; however, the present invention is not restricted to these examples.

### Production Example 1

Five grams (5 g) of sodium ligninsulfonate (commercial name: REAX 910, HLB=15 or more, manufactured by Westovaco) was dissolved in 93 g of water. One hundred and one grams (101 g) of flumioxazin (purity 99.2%) and 1 g of silicone emulsion (commercial name: Antifoam CE, manufactured by Dow Corning) were added thereto and stirred with 300 g of glass beads having 1.0 mm in diameter by Three-one Motor (stirrer produced by Shinto Scientific) for two hours to give 200 g of flumioxazin/water slurry having 5.0 μm of volume median diameter of flumioxazin.

Into 150.2 g of water, 1 g of silicone emulsion (commercial name: Antifoam CE, manufactured by Dow Corning), 435.5 g of a 62% aqueous solution of glyfosate isopropylamine salt and 200 g of the above-obtained flumioxazin/water slurry were added, and stirred at 5000 rpm with a high speed disperser at about 25° C. After 10 minutes from the start of stirring, 20 g of a mixture of silica and aluminum oxide (commercial name: Aerosil COK-84, manufactured by Degussa-Huls) were added. And 2.5 g of synthetic hydrated lithium sodium magnesium silicate (commercial name: Raponite RD, manufactured by Lockwood) were added after 20 minutes, and 60 g of methyl oleate (manufactured by Wako Chemical), 70 g of polyoxyethylene(5)oleyl/cetyl ether (Emalsogen M, HLB=9, manufactured by Clariant), 60 g of polyoxyethylene tallowamine (Wittocoamine TAM-45, HLB=9-10, manufactured by AkzoNobel) and 50 g of propylene glycol after 30 minutes. Further, after stirring at 5000 rpm for 10 minutes, water was added thereto to make the total 1000 ml to give a herbicidal composition of the present invention.

### Production Example 2

The same procedure as Production example 1, except that 5 g of bentonite (Kunipia G, manufactured by Kunimine Kogyo) in place of 2.5 g of synthetic hydrated lithium sodium magnesium silicate (commercial name: Raponite RD, manufactured by Lockwood) and 40 g of polyoxyethylene tallow amine (Wittocoamine TAM-45, HLB=9-10, manufactured by AkzoNobel) in place of 60 g were used, to give a herbicidal composition of the present invention.

### Production Example 3

The same procedure as Production example 1, except that 5 g of smectite (Benton EW, manufactured by Elementis) in place of 2.5 g of synthetic hydrated lithium sodium magnesium silicate (commercial name: Raponite RD, manufactured by Lockwood), 40 g of polyoxyethylene tallowamine (Wittocoamine TAM-45, HLB=9-10, manufactured by AkzoNobel) in place of 60 g and 60 g of polyoxyethylene(5) oleyl/cetyl ether (Emalsogen M, HLB=9, manufactured by Clariant) in place of 70 g were used, to give a herbicidal composition of the present invention.

### Test Example

Each 100 ml of the herbicidal compositions of the present invention obtained by Production examples 1-3 was charged into a glass screw tube and allowed to stand at 40° C. for one month. After that, all of the herbicidal compositions of the present invention were observed to be homogeneous and not separated.

The herbicidal composition of the present invention provides an aqueous flowable herbicidal formulation comprising a protoporphyrinogen oxidase inhibiting herbicidal active ingredient and a water-soluble herbicidal active ingredient that has excellent suspension stability.

What is claimed is:

1. A herbicidal composition which comprises a protoporphyrinogen oxidase inhibiting herbicidal active ingredient, a water-soluble herbicidal active ingredient, a water-soluble anionic surfactant, a polyoxyalkylenehydrocarbylamine, a water-immiscible organic solvent in which the protoporphyrinogen oxidase inhibiting herbicidal active ingredient cannot be substantially dissolved, a thickner and water, wherein the protoporphyrinogen oxidase inhibiting herbicidal active ingredient is suspended in the water dissolving the water-soluble herbicidal active ingredient as solid fine particles.

2. The herbicidal composition according to claim 1, wherein the water-soluble anionic surfactant is a salt of ligninsulfonic acid.

3. The herbicidal composition according to claim 1, wherein the protoporphyrinogen oxidase inhibiting herbicidal active ingredient is N-(7-fluoro-3,4-dihydro-3-oxo-4-prop-2-ynyl-2H-1,4-benzoxadin-6-yl(cyclohex-1-en-1,2-dicarboxamide.

4. The herbicidal composition according to claim 3, wherein the water-immiscible organic solvent is methyl oleate.

5. The herbicidal composition according to claim 1, wherein the protoporphyrinogen oxidase inhibiting herbicidal active ingredient is N-(7-fluoro-3,4-dihydro-3-oxo-4-prop-2-ynyl-2H-1,4-benzoxadin-6-yl)cyclohex-1-en-1,2-carboxamide, the water-soluble anionic surfactant is a salt of ligninsulfonic acid, the water-immiscible organic solvent is methyl oleate, and the weight ratio of the protoporphyrinogen oxidase inhibiting herbicidal active ingredient/the water-soluble anionic surfactant/polyoxyalkylenehydrocarbylamine/the water-immiscible organic solvent is 1/0.01-1/0.01-2/0.1-2.

6. The herbicidal composition according to claim 1, wherein the water-soluble herbicidal active ingredient is N-phosphonomethylglycine or its salt.

7. The herbicidal composition according to claim 3, wherein the water-soluble herbicidal active ingredient is N-phosphonomethylglycine or its salt, and the weight ratio of the protoporphyrinogen oxidase inhibiting herbicidal active ingredient and the water-soluble herbicidal active ingredient is 4.5/1 to 1/10.

8. The herbicidal composition according to claim 1, wherein the thickner is magnesium silicate.
